(19) United States
(12) Patent Application Publication
(10) Pub. No.: US 2024/0139853 A1
(43) Pub. Date: May 2, 2024

(54) TIP SEPARATION APPARATUS OF WELDING GUN

(71) Applicant: ATRON CO., LTD., Siheung-si (KR)

(72) Inventor: Jong Chan LIM, Suwon-si (KR)

(73) Assignee: ATRON CO., LTD., Siheung-si (KR)

(21) Appl. No.: 18/384,949

(22) Filed: Oct. 30, 2023

(30) Foreign Application Priority Data
Nov. 2, 2022 (KR) 10-2022-0144288

(51) Int. Cl. B23K 11/30; B23K 11/31

(52) U.S. Cl. CPC B23K 11/3072; B23K 11/314

(57) ABSTRACT

Disclosed is a tip separation apparatus of a welding gun, which mechanically separates consumable tips installed at the end of the welding gun in a robot welding machine. The tip separation apparatus includes tip seating stands coupled to a main plate configured to maintain level, and configured such that each of the tip seating stands has a first insertion hole, into which a corresponding one of tips coupled to fingers of the welding gun is inserted, tip separation units rotatably disposed on bottom surfaces of the tip seating stands and configured to press outer circumferential surfaces of the tips inserted into the first insertion holes of the tip seating stands so as to clamp the tips and to rotate the clamped tips so as to separate the tips from the welding gun, and a housing configured to rotatably receive the tip separation units in a state of being elastically supported.

### BACKGROUND OF THE INVENTION

### Field of the Invention

The present invention relates to a tip separation apparatus of a welding gun, and more particularly, to a tip separation apparatus of a welding gun, which mechanically separates consumable tips installed at the end of the welding gun in a robot welding machine configured to perform spot welding.

### Description of the Related Art

In general, a robot welding machine is widely used to perform welding between iron plates or spot welding between an iron plate and a structural material on a vehicle body welding line or the like.

The robot welding machine may perform various motions and work quickly, and may thus be essential equipment.

Tips are installed at the end of a welding gun of the robot welding machine. The tips are parts in which discharge occurs and are worn away due to use, and thus, the tips are consumable products which need to be periodically replaced.

The tip is coupled to a finger of the welding gun in a press fitting manner so as to be easily replaceable, taper parts are formed on the outer circumferential surface of the finger of the welding gun and the inner circumferential surface of the tip, and the tip is firmly coupled to the finger, when the tip is pressed to be inserted into the finger of the welding gun, and is separated from the finger, when the tip coupled to the finger is slightly rotated.

As such, conventional replacement of the tips was performed manually by a worker, and the applicant of the present invention suggested an apparatus configured to rapidly replace tips of a welding gun through automation, entitled “apparatus for separating tips of welding gun” disclosed in Korean Patent Registration No. 10-1603943.

However, in Korean Patent Registration No. 10-1603943, a clamping unit and a rotating unit configured to separate the tips from the welding gun are too complicated in structure, mechanical coupling between respective structures requires preciseness, and thus, the tip separation apparatus may malfunction or may be difficult to maintain and repair.

### SUMMARY OF THE INVENTION

Therefore, the present invention has been made in view of the above problems, and it is an object of the present invention to provide a tip separation apparatus of a welding gun, which is configured to mechanically separate consumable tips installed at the end of the welding gun in a robot welding machine, and has a simple structure, so as to prevent malfunction and to be simply maintained and repaired.

In accordance with the present invention, the above and other objects can be accomplished by the provision of a tip separation apparatus of a welding gun, the tip separation apparatus including tip seating stands coupled to a main plate configured to maintain level, and configured such that each of the tip seating stands has a first insertion hole, into which a corresponding one of tips coupled to fingers of the welding gun is inserted, tip separation units rotatably disposed on bottom surfaces of the tip seating stands and configured to press outer circumferential surfaces of the tips inserted into the first insertion holes of the tip seating stands so as to clamp the tips and to rotate the clamped tips so as to separate the tips from the welding gun, and a housing configured to rotatably receive the tip separation units in a state of being elastically supported.

Each of the tip separation units may include a rotating body disposed in the housing so as to be elastically supported and configured to have an accommodation recess formed on a surface of the rotating body to be stepped therefrom and a second insertion hole formed at a center of the surface of the rotating body such that a corresponding one of the tips after passing through the first insertion holes is inserted thereinto, a compression latch rotatably disposed in the accommodation recess of the rotating body and configured to have a tooth part configured to press an outer circumferential surface of the tip inserted into the second insertion hole, and a lever connected to a power source, disposed such that one side thereof in a state of being spaced apart from an axis of the rotating body is rotatably disposed in the accommodation recess, primarily rotated to press the compression latch so that the tip is clamped by the tooth part, and secondarily rotated to rotate the rotating body together with the clamped tip on the housing.

A position fixing piece configured to come into contact with one side of the lever and to have a designated slope so as to maintain an initial position of the lever, and a contact piece bent from the position fixing piece to transmit rotational force of the lever rotated after clamping of the tip to the rotating body so as to rotate the rotating body in conjunction with the lever may be formed at one side of the accommodation recess.

A pushing cam configured to have a designated curved surface so as to push the tooth part of the compression latch toward the tip inserted into the second hole in a state in which the pushing came comes into contact with the compression latch when the lever is rotated may be formed at an end of one side of the lever.

A fixing cover configured to cover the accommodation recess and to have a through hole formed at a center of the fixing cover so that the tip having passed through the first insertion hole penetrates the through hole may be coupled to the rotating body.

A tip extractor configured to separate the clamped tip from a corresponding one of the fingers of the welding gun during rotation of the clamped tip may be provided on each of the tip separation units, the tip extractor may include a plurality of guide cams configured to protrude from an upper surface of the rotating body along a circumference thereof and to have a slope of a designated length, and a plurality of rollers disposed on the bottom surface of the rotating body and configured to come into contact with the guide cams so as to perform rolling motion, and, when the rotating body is rotated together with the clamped tip, sloped surfaces of the rotated guide cams may be pressed by the rolling rollers, and the clamped tip may be separated from the corresponding one of the fingers of the welding gun thereby.

The tip separation units may be provided in a pair to be spaced apart from each other, and may be disposed in a state of being supported by an elastic member in the housing.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a plane view of a tip exchange apparatus in which a tip separation apparatus according to the present invention is provided;

FIG. 2 is a partial exploded perspective view showing the tip separation apparatus according to the present invention;

FIG. 3 is an exploded perspective view of the tip separation apparatus shown in FIG. 2;

FIG. 4 is an exploded perspective view of a tip separation unit among elements shown in FIG. 3;

FIG. 5 is an assembled cross-sectional view of the tip separation apparatus shown in FIG. 3;

FIG. 6 is a plan view of the tip separation unit from which a fixing cover is removed;

FIGS. 7(a) and 7(b) are partial cross-sectional views taken along line I-I of FIG. 2, showing the structure and operating state of a tip extractor; and

FIGS. 8(a) to 8(c) are views illustrating a process of clamping and rotating a tip in the state shown in FIG. 6.

### DETAILED DESCRIPTION OF THE INVENTION

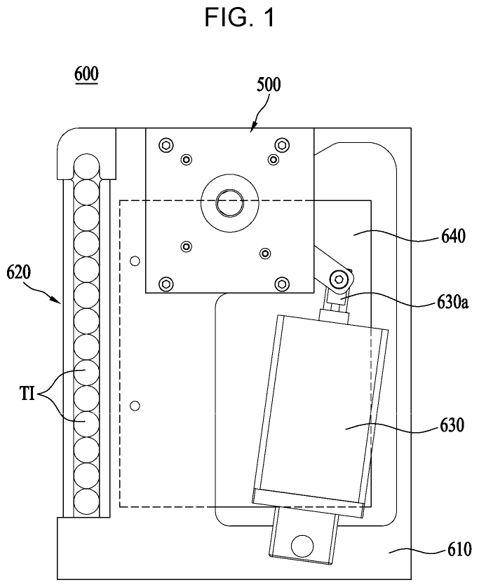

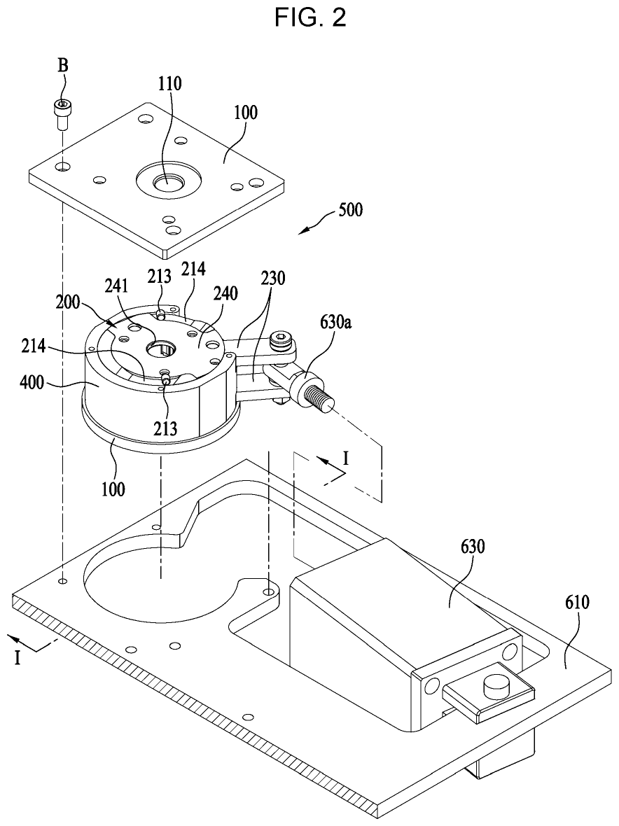

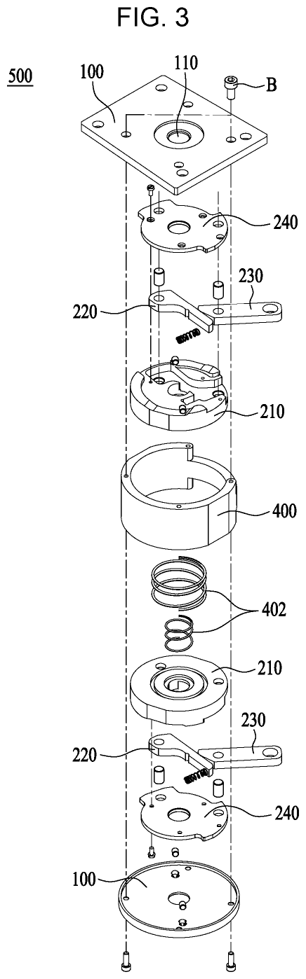

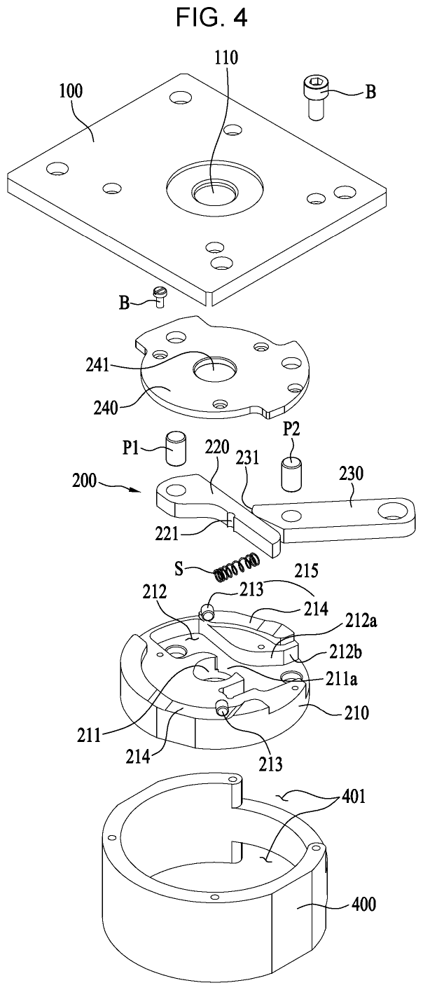

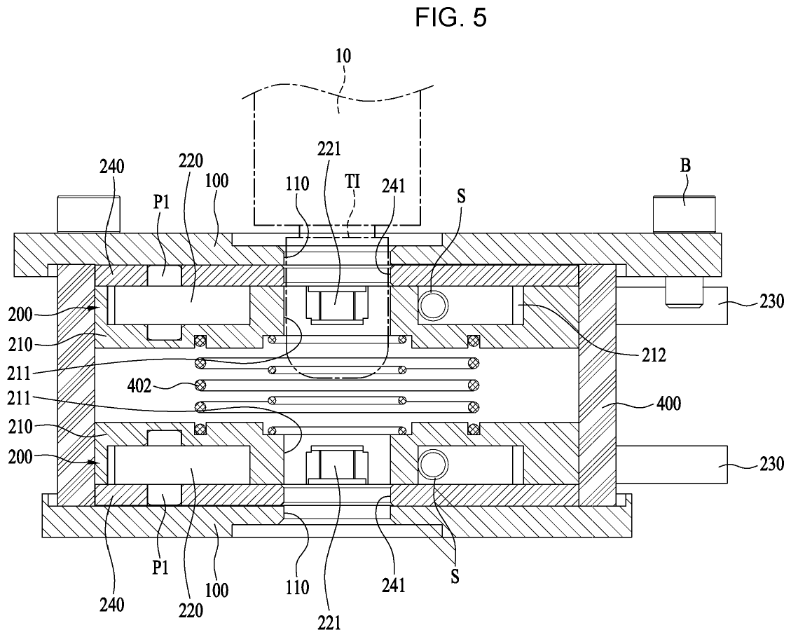

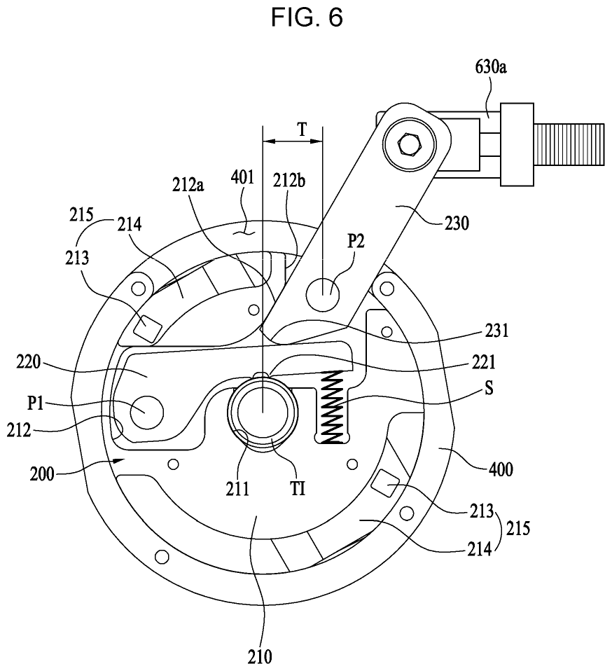

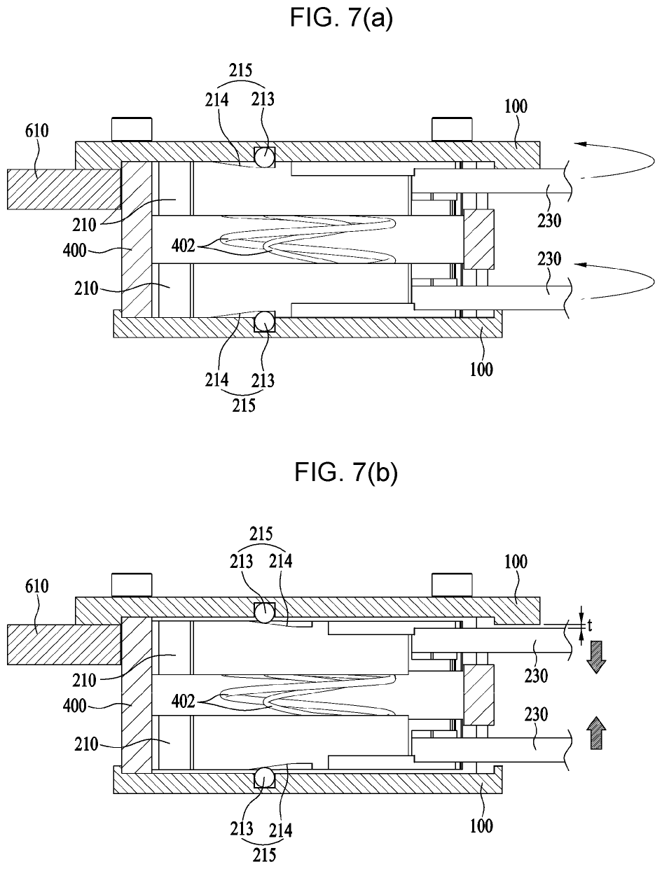

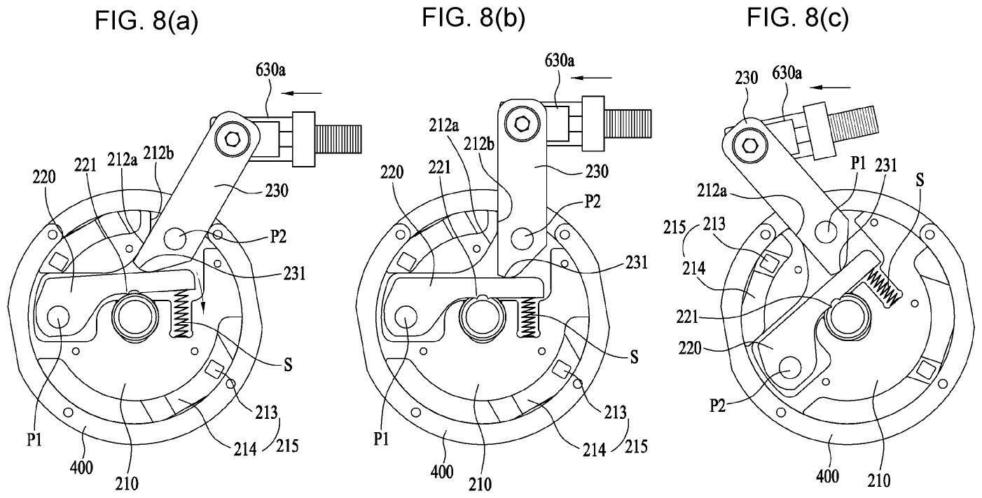

FIG. 1 is a plane view of a tip exchange apparatus in which a tip separation apparatus according to the present invention is provided, FIG. 2 is a partial exploded perspective view showing the tip separation apparatus according to the present invention, FIG. 3 is an exploded perspective view of the tip separation apparatus shown in FIG. 2, FIG. 4 is an exploded perspective view of a tip separation unit among elements shown in FIG. 3, FIG. 5 is an assembled cross-sectional view of the tip separation apparatus shown in FIG. 3, FIG. 6 is a plan view of the tip separation unit from which a fixing cover is removed, FIGS. 7(a) and 7(b) are partial cross-sectional views taken along line I-I of FIG. 2, showing the structure and operating state of a tip extractor, and FIGS. 8(a) to 8(c) are views illustrating a process of clamping and rotating a tip in the state shown in FIG. 6.

A welding gun (not shown) of a robot welding machine is operated by a robot. The welding gun has a shape similar to a C-type clamp, and is configured such that upper and lower fingers 10 are operated upwards and downwards to perform welding. In general, the upper finger 10 is generally installed vertically, and the lower finger 10 is not installed in this orientation in many cases.

The upper finger 10 is operated in the vertical direction so as to form a contact point between tips TI coupled to the upper and lower fingers 10.

As described above, when the tip TI in the firmly clamped state is slightly twisted like when opening a bottle cap, the tip TI may be easily removed (or separated) from the finger 10 of the welding gun. The tip separation apparatus according to the present invention has a configuration and functions so as to mechanically perform such a separation operation.

In the case that the tip TI is very strongly coupled to the finger 10, slight twisting of the tip TI may not be sufficient. Therefore, the tip TI is smoothly separated from the finger 10 by applying force in a direction of pulling the tip while twisting the tip TI.

The present invention provides a tip separation apparatus 500, which may consecutively execute an operation of clamping and twisting a tip TI and an operation of pulling the tip TI.

As shown in FIGS. 1 to 8(c), the tip separation apparatus 500 according to the present invention includes tip seating stands 100 coupled to a main plate 610 configured to maintain level, and configured such that each of the tip seating stands 100 has a first insertion hole 110, into which a corresponding one of tips TI coupled to the fingers 10 of the welding gun is inserted, tip separation units 200 rotatably disposed on the bottom surfaces of the tip seating stands 100 and configured to press the outer circumferential surfaces of the tips TI inserted into the first insertion holes 110 of the tip seating stands 100 so as to clamp the tips TI and to rotate the clamped tips TI so as to separate the tips TI from the welding gun, and a housing 400 configured to rotatably receive the tip separation units 200 in a state of being elastically supported.

Prior to description, the tip separation apparatus 500 according to the present invention is characterized in that the tip separation units 200 configured to separate the tips TI from the welding gun have an improved structure so as to prevent malfunction and to be easily maintained and repaired.

Further, although members configured to elastically support structures, which will be described below, or to provide elasticity to the structures will be described as compression springs, any members having elasticity may be used without being limited in kind.

Further, coupling bolts B provided to execute coupling between respective structures are not limited in length and kind, and are denoted by the same reference numeral.

As shown in FIG. 1, the tip separation apparatus 500 according to the present invention is installed on a tip exchange apparatus 600 through the main plate 610, a tip mount 620 configured to sequentially supply tips TI to the welding gun is disposed at one side of the tip separation apparatus 500, and a cylinder 630 serving as a power source configured to supply power to rotate a pair of levers 230, which will be described below, of the tip separation apparatus 500 is provided at the other side of the tip separation apparatus 500.

Further, a center adjuster 640 configured to adjust the horizontal tilt of the main plate 610 so as to correspond to directionality of the welding gun into which the tips TI are inserted is provided on the bottom of the main plate 610.

This embodiment relates to the tip separation apparatus 500 which is a part of the tip exchange apparatus 600, and a detailed description of the tip mount 620, the main plate 610 and the center adjuster 640 will thus be omitted.

First, a pair of tip separation units 200 having the same structure, which will be described below, is provided, is disposed to be spaced apart from each other so as to be located at upper and lower regions in the housing 400, and is supported by at least one elastic member 402, as shown in FIGS. 3 and 5.

Here, the elastic member 402 may be a compression spring S which generates repulsive force when compressed.

The tip seating stand 100 disposed on the housing 400 in the drawings has a rectangular shape so as to be coupled to the main plate 610, and the tip seating stand 100 disposed under the housing 400 in the drawings has a circular shape corresponding to the housing 400 so as to be coupled to the housing 400.

In this embodiment, the pair of tip separation units 200 have the same structure, and thus, the tip separation unit 200 disposed in the upper region in the drawings will be described below in order to prevent confusion of explanations.

The tip seating stand 100 is formed in the shape of a rectangular plate having a designated area, and is coupled to the main plate 610 configured to maintain level.

The first insertion hole 110 having a circular shape facing vertically in the drawings may be formed through the center of the tip seating stand 100 so that the tip TI coupled to the finger 10 of the welding gun is inserted into (penetrates) the first insertion hole 110.

The tip separation unit 200 serves to separate the tip TI received in the tip separation unit 200 from the finger of the welding gun, is rotatably disposed on the bottom surface of the top seating stand 100, presses the outer circumferential surface of the tip TI inserted into the first insertion hole 110 of the tip seating stand 100 so as to clamp the tip TI, and rotates the clamped tip TI about the axial direction in which the tip TI is inserted into the first insertion hole 110 so as to separate the tip TI from the finger 10.

For this purpose, the tip separation unit 200 includes a rotating body 210, a compression latch 220, a lever 230, and a fixing cover 240, as shown in FIGS. 2 to 8(c).

The rotating body 210 has a circular shape having a designated thickness corresponding to the inner diameter of the housing 400, which will be described below, and is disposed in the housing 400 in a state of being elastically supported by the elastic members 402.

An accommodation recess 212 stepped from the upper surface of the rotating body 210 is formed on the upper surface of the rotating body 210 in the drawings so as to receive the compression latch 220 and the lever 230, and the accommodation recess 212 is formed to have a space specified to radiuses of rotation of the compression latch 220 and the lever 230 so that the compression latch 220 and the lever 230 may be respectively rotated.

Here, a position fixing piece 212a configured to come into contact with one side of the lever 230, which will be described below, and to have a designated slope so as to maintain the initial position of the lever 230, and a contact piece 212b bent vertically upwardly from the position fixing piece 212a in the drawings to transmit the rotational force of the lever 230 rotated after clamping of the tip TI by the compression latch 220 to the rotating body 210 so as to rotate the rotating body 210 in conjunction with the lever 230 are formed at one side of the accommodation recess 212, as shown in FIGS. 4 and 6.

That is, the position fixing piece 212a and the contact piece 212b of the accommodation recess 212 allow the lever 230 to maintain the initial position thereof at all times after extraction of the tip TI, and allow the lever 230 and the rotating body 210 to be operated together so that tip TI may be extracted by a tip extractor 215, which will be described below.

In addition, a second insertion hole 211 configured to vertically penetrate the rotating body 210 is formed through the center of the surface of the rotating body 210 so that the tip TI having passed through the first insertion hole 110 of the tip seating stand 100 is inserted into the second insertion hole 211.

Further, an opening 211a communicating with the accommodation recess 212 is formed at one side of the second insertion hole 211 so that a tooth part 221 of the compression latch 220, which will be described below, may enter the inside of the second insertion hole 211 through the opening 211a.

The compression latch 220 has a bar shape having a designated length, and one longitudinal side (the left side in the drawings) of the compression latch 220 is installed in the accommodation recess 212 of the rotating body 210 by a first rotating pin P1 so that the compression latch 220 may be rotated about the first rotating pin P1 in the accommodation recess 212, as shown in FIGS. 4 and 6.

The tooth part 221 configured to press the outer circumferential surface of the tip TI inserted into the second insertion hole 211 of the rotating body 210 through the first insertion hole 110 of the tip seating stand 100 so as to clamp the tip TI is formed at the other longitudinal side (the right side in the drawings) of the compression latch 220, and the tooth part 221 includes a plurality of pointy teeth so as to pierce the outer circumferential surface of the tip TI.

Further, a compression spring S, which elastically supports the tooth part 221 so as to restore the compression latch 220 when compression applied to the lever 230 is released after clamping the tip TI by the compression latch 220 rotated by the lever 230, which will be described below, is disposed at the end of the other side of the compression latch 220 adjacent to the tooth part 221.

In the state in which the lever 230 maintains a designated length, one side of the lever 230 is received in the accommodation recess 212 of the rotating body 210 and installed in the accommodation recess 212 by a second rotating pin P2 so that the lever 230 may be rotated about the second rotating pin P2, and the other side of the lever 230 is exposed to the outside of the housing 400, which will be described below.

Here, the second rotating pin P2 may be disposed to be spaced apart from the axis of the rotating body 210 by a designated distance T, as shown in FIG. 6, and the reason for this is that primary rotation of the lever 230 itself and secondary rotation of the lever 230 together with the rotating body 210 may be consecutively carried out by differing the axes of the second rotating pin P2 and the rotating body 210 from each other.

That is, the lever 230 itself is primarily rotated around the second rotating pin P2, in the state in which the lever 230 does not affect rotation of the rotating body 210, and thus rotates the compression latch 220 so that the tooth part 222 compresses the tip TI to clamp the tip TI, and, when the lever 230 is secondarily rotated, the lever 230 itself is not rotated around the second rotating pin P2 any longer because the lever 230 is in the contact state with the contact piece 212b of the rotating body 210, the rotational force of the lever 230 is transmitted to the rotating body 210, and thus, the lever 230 rotates the rotating body 210 together with the clamped tip TI in the housing 400, which will be described below (with reference to FIGS. 8(a) and 8(b)).

In more detail, the lever 230 itself is rotated around the second rotating pin P2 so as to press and clamp the tip TI until the lever 230 comes into contact with the contact piece 212b of the rotating body 210 during primary rotation, and then, the lever 230 rotates the rotating body 210 while pushing the contact piece 212b during secondary rotation, thereby being capable of implementing operation of the tip extractor 215, which will be described below.

Further, primary rotation of the lever 230 itself is more stably carried out by friction between the rotating body 210 and the tip seating stand 100 by the repulsive force of the elastic members 402 disposed in the housing 400 and elastically supporting the respective rotating bodies 210, as shown in FIG. 5.

In order to perform the above-described operation of the lever 230, a pushing cam 231 configured to have a designated curved surface toward the compression latch 220 and to come into contact with the region of the compression latch 220 having the tooth part 221 during rotation of the lever 230 and thus to push the compression latch 220 so as to rotate the compression latch 220 is formed at the end of the left side of the lever 230 in the drawings, thereby causing the tooth part 221 to enter the opening 211a of the second insertion hole 211 of the rotating body 210 so as to clamp the tip TI inserted into the second insertion hole 211.

In addition, the cylinder 630 operated by fluid pressure is disposed at the other side of the cylinder 230 as a power source configured to rotate the lever 230 in the accommodation recess 212 of the rotating body 210, and the end of the other side of the lever 230 is connected to a rod 630a of the cylinder 630 by a link, as shown in FIG. 1.

Thereby, the lever 230 is rotated around the second rotating pin P2 in the accommodation recess 212 of the rotating body 210 depending on movement of the rod 630a of the cylinder 630.

The fixing cover 240 is disposed on the upper surface of the rotating body 210 so as to cover the upper surface of the rotating body 210, and thus prevents the compression latch 220 and the lever 230 received in the accommodation recess 212 from being exposed to the outside, thereby enabling the compression latch 220 and the lever 230 to be stably rotated.

Further, a through hole 241 is formed through the center of the fixing cover 240 so that the tip TI inserted into the second insertion hole 211 through the first insertion hole 110 penetrates the through hole 241.

In addition, grooves (no reference numeral) having a shape corresponding to the inner surfaces of a plurality of guide cams 214, which will be described below, formed on the circumference of the upper surface of the rotating body 210 so as to expose the guide cams 214 are formed on the outer circumference of the fixing cover 240, as shown in FIGS. 2 and 4.

The tip extractor 215 configured to separate the clamped tip TI from the finger 10 of the welding gun during rotation of the tip TI by the rotating body 210 is provided on the tip separation unit 200.

The tip extractor 215 includes the plurality of guide cams 214 protruding from the upper surface of the rotating body 210 along the circumference of the rotating body 210 and having a slope of a designated length, and a plurality of rollers 215 disposed on the bottom surface of the rotating body 210 and configured to come into contact with the surfaces of the guide cams 214 so as to perform rolling motion when the rotating body 210 is coupled to the tip seating stand 100, as shown in FIGS. 4, 7(a) and 7(b).

Here, two guide cams 214 are formed to protrude along the circumference of the upper surface of the rotating body 210, and the slopes of the guide cams 214 are formed to face in the same circumferential direction.

Although this embodiment illustrates that two guide cams 214 are formed on the rotating body 210, the number of the guide cams 214 is not limited thereto, and two guide cams 214 or three or more guide cams 214 may be formed depending on the shape and structure of the rotating body 210.

The rollers 213 are formed in a cylindrical bar shape so as to come into line contact with the surfaces of the guide cams 214, and are supported by the sloped surfaces of the guide cams 214 and perform rolling motion in the state in which the rollers 213 are inserted into recesses (no reference numeral) formed on the bottom surface of the tip seating stand 100, as shown in FIGS. 7(a) and 7(b).

The tip extractor 215 causes the sloped surfaces of the rotated guide cams 214 to be gradually pressed by the rollers 213 which perform rolling motion, when the rotating body 210 is rotated together with the clamped tip TI, as shown in FIGS. 7(a) and 7(b), and consequently, causes the rotating body 210 to be received in the housing 400, which will be described below, so as to separate the clamped tip TI from the finger 10 of the welding gun.

The housing 400 formed in a cylindrical shape having openings at upper and lower parts thereof is coupled to the tip seating stands 100 by the coupling bolts B, and receives the pair of tip separation units 200 such that the tip separation units 200 in the state of being elastically supported are rotatable.

A pair of rotation holes 401 configured to expose the respective levers 230 to the outside so as to connect the levers 230 to the cylinder 630 among the respective elements of the pair of tip separation units 200 and to control the set radius of rotation of the levers 230 when the levers 230 are rotated around the second rotating pins P2 by the cylinder 630 is formed at upper and lower parts of a designated position of the housing 400

Hereinafter, a process of separating (removing) tips TI from the welding gun using the tip separation apparatus 500 according to the present invention will be described with reference to the accompanying drawings.

Among the pair of tip separation units 200, operation of the tip separation unit 200 disposed in the upper region in the drawings will be described as one example.

First, a tip TI coupled to the finger 10 of the welding gun, which is to be replaced, is inserted into the first insertion hole 110 of the tip seating stand 100.

Here, the tip TI is disposed to penetrate the first insertion hole 110 of the tip seating stand 010, the through hole 241 of the fixing cover 240, and the second insertion hole 211 of the rotating body 210, as shown by an alternated long and short dash line in FIG. 5.

When insertion of the tip TI has been completed, the cylinder 630 is driven to move the rod 630a, and thus, the lever 230 is primarily rotated in the direction of an arrow shown in FIG. 8(a) from the state shown in FIG. 8(a) to the state shown in FIG. 8(b), and the inserted tip TI is clamped thereby.

Here, rotation of the lever 230 is carried out until the lever 230 comes into contact with the contact piece 212b of the rotating body 210.

Further, the lever 230 itself is rotated around the second rotating pin P2, and thus does not affect rotation of the rotating body 210.

Moreover, during such a primary rotating process of the lever 230, the pushing cam 231 presses the compression latch 220 in the downward direction in the drawings, the compression latch 220 is rotated while being supported by elasticity of the compression spring S, as shown in FIG. 8(b), the tooth part 221 of the compression latch 220 is strongly pressed into the outer circumferential surface of the tip TI during this process, and thereby, clamping of the tip TI by the compression latch 220 is completed, as shown in FIG. 8(b).

Thereafter, the lever 230 starts to be secondarily rotated in the direction of an arrow shown in FIG. 8(b) by an increased load of the cylinder 630.

Here, because the lever 230 is in the state in which one side of the lever 230 comes into contact with the contact piece 212b, as shown in FIG. 8(b), the lever 230 maximally rotates the rotating body 210 while pushing the contact piece 212b during secondary rotation, as shown in FIG. 8(c).

During the secondary rotating process of the lever 230, the rollers 213 of the tip extractor 215 roll along the sloped surfaces of the guide cams 214 when the rotating body 210 is rotated in the state shown in FIG. 7(a), and thus gradually press the sloped surfaces of the guide cams 214, thereby lowering the rotating body 210 by a distance t shown in FIG. 7(b) into the housing 400.

During such a process, the tip TI clamped by the compression latch 220 is separated from the finger 10 of the welding gun in conjunction with descent of the rotating body 210.

Here, because the respective levers 230 of the pair of tip separation units 200 are coupled to one rod 630a, as shown in FIG. 2, the tip separation units 200 are simultaneously driven, but, when a worker wants to drive one tip separation unit 200, only a corresponding one of the levers 230 may be connected to the rod 630a.

Thereafter, when the rod 630a is returned to an initial position thereof by driving the cylinder 630, the lever 230 and the compression latch 220 are returned to initial positions thereof in conjunction with the rod 630a, as shown in FIG. 8(a), and then, the tip TI separated from the finger 10 of the welding gun is discharged.

As described above, the tip separation apparatus according to the present invention simplifies the mechanical structure of the tip separation units configured to mechanically separate tips installed at the end of the welding gun of the robot welding machine, thereby being capable of preventing malfunction due to the conventional complicated structure and being simply maintained and repaired.

As is apparent from the above description, the present invention provides a tip separation apparatus of a welding gun which simplifies the mechanical structure of tip separation units configured to mechanically separate tips installed at the end of the welding gun of a robot welding machine, so as to prevent malfunction due to the conventional complicated structure and to be simply maintained and repaired.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A tip separation apparatus of a welding gun, the tip separation apparatus comprising:
tip seating stands coupled to a main plate configured to maintain level, and configured such that each of the tip seating stands has a first insertion hole, into which a corresponding one of tips coupled to fingers of the welding gun is inserted;
tip separation units rotatably disposed on bottom surfaces of the tip seating stands and configured to press outer circumferential surfaces of the tips inserted into the first insertion holes of the tip seating stands so as to clamp the tips and to rotate the clamped tips so as to separate the tips from the welding gun; and
a housing configured to rotatably receive the tip separation units in a state of being elastically supported,
wherein each of the tip separation units comprises a rotating body disposed in the housing so as to be elastically supported and configured to have an accommodation recess formed on a surface of the rotating body to be stepped therefrom and a second insertion hole formed at a center of the surface of the rotating body such that a corresponding one of the tips after passing through the first insertion holes is inserted thereinto, a compression latch rotatably disposed in the accommodation recess of the rotating body and configured to have a tooth part configured to press an outer circumferential surface of the tip inserted into the second insertion hole, and a lever connected to a power source, disposed such that one side thereof in a state of being spaced apart from an axis of the rotating body is rotatably disposed in the accommodation recess, primarily rotated to press the compression latch so that the tip is clamped by the tooth part, and secondarily rotated to rotate the rotating body together with the clamped tip on the housing,
wherein a pushing cam configured to have a designated curved surface so as to push the tooth part of the compression latch toward the tip inserted into the second hole in a state in which the pushing came comes into contact with the compression latch when the lever is rotated is formed at an end of one side of the lever.

2. The tip separation apparatus according to claim 1, wherein a position fixing piece configured to come into contact with one side of the lever and to have a designated slope so as to maintain an initial position of the lever, and a contact piece bent from the position fixing piece to transmit rotational force of the lever rotated after clamping of the tip to the rotating body so as to rotate the rotating body in conjunction with the lever are formed at one side of the accommodation recess.

3. The tip separation apparatus according to claim 1, wherein a fixing cover configured to cover the accommodation recess and to have a through hole formed at a center of the fixing cover so that the tip having passed through the first insertion hole penetrates the through hole is coupled to the rotating body.

4. The tip separation apparatus according to claim 1, wherein a tip extractor configured to separate the clamped tip from a corresponding one of the fingers of the welding gun during rotation of the clamped tip is provided on each of the tip separation units,
wherein the tip extractor comprises:
a plurality of guide cams configured to protrude from an upper surface of the rotating body along a circumference thereof and to have a slope of a designated length; and
a plurality of rollers disposed on the bottom surface of the rotating body and configured to come into contact with the guide cams so as to perform rolling motion,
wherein, when the rotating body is rotated together with the clamped tip, sloped surfaces of the rotated guide cams are pressed by the rolling rollers, and the clamped tip is separated from the corresponding one of the fingers of the welding gun thereby.

5. The tip separation apparatus according to claim 1, wherein the tip separation units are provided in a pair to be spaced apart from each other, and are disposed in a state of being supported by an elastic member in the housing.
